(19) United States
(12) Patent Application Publication
(10) Pub. No.: US 2013/0233181 A1
(43) Pub. Date: Sep. 12, 2013

(54) Combination Food Steamer and Food Processor

(71) Applicants: Michael Allen, Glen Allen, VA (US); Claire Ashley, Midlothian, VA (US); Drew Carlson, Henrico, VA (US); Ernest B. Pryor, JR., Maidens, VA (US); Mark C. Steiner, Midlothian, VA (US); Marta Phillips, Midlothian, VA (US)

(72) Inventors: Michael Allen, Glen Allen, VA (US); Claire Ashley, Midlothian, VA (US); Drew Carlson, Henrico, VA (US); Ernest B. Pryor, JR., Maidens, VA (US); Mark C. Steiner, Midlothian, VA (US); Marta Phillips, Midlothian, VA (US)

(21) Appl. No.: 13/416,099

(22) Filed: Mar. 9, 2012

(51) Int. Cl. A47J 27/04; A47J 43/07

(52) U.S. Cl. 99/337; 99/353

(57) ABSTRACT

A combination food steamer and food processor appliance includes a housing surrounding a motor and a heater. A water cavity is positioned within the housing. At least a portion of a drive shaft extends upwardly beyond a first end of the housing. A jar is removably mountable to the first end of the housing. Portions of a bottom wall and a side wall of the jar define a food processing cavity. A steam cavity is also defined in the jar. At least a portion of the drive shaft extends through a portion of the bottom wall of the jar when the jar is mounted to the housing. A lid is removably mountable to a rim of the side wall of the jar. A basket is removably mountable within the food processing cavity of the jar in a first operating configuration. Portions of a bottom wall and a side wall of the basket define a food steaming cavity.

### SUMMARY

The present disclosure relates generally to a kitchen appliance and, more particularly, to a combined food steamer and food processor appliance that provides the functionality of steaming and processing foodstuff in a single, generally compact device.

### BACKGROUND

Steaming is considered an excellent way to prepare and serve vegetables. It is thought to maximize their nutritional value as other cooking techniques can remove vitamins, minerals and antioxidants from the food. Steamed vegetables are also thought to be the most flavorful and easiest to digest. As such, there is growing trend of healthcare professionals, dieticians, and chefs that recommend steaming food and convey the advantages of steaming food such as vegetables. Unfortunately, the consumer often finds it too difficult or time consuming to comply with the advice and recommendations.

Traditionally, baby food is prepared by boiling or steaming vegetables to retain the maximum amount of nutrients, and subsequently mashing or blending the vegetables and allowing the same to cool before feeding to a child. Baby food is frequently made by steaming the foodstuff in one device and then placing the steamed foodstuff into a separate blender or food processor for mashing/blending.

While two separate appliances, namely a steamer and a blender, have long been employed for making puréed food, such as baby food, at least one appliance has been designed to provide both functions in a single device. U.S. Pat. No. 6,076,452 (“Dessuise”) is one such prior art device that is able to both steam and blend foodstuff. While the device disclosed by Dessuise may adequately perform its intended functions, the device of Dessuise has a relatively large footprint, which is not preferred in typical kitchens where countertop space is limited. In addition, the device of Dessuise does not provide or permit entry of foodstuff into a blending or processing chamber without first removing a lid from the device. As such, a user's options when operating the device are rather limited.

There is a continuing need for an appliance that provides multiple functions, including steaming, which are typically found in disparate kitchen appliances. However, a new multi-functional kitchen appliance would ideally be capable of both steaming foodstuff and blending or processing foodstuff in a single, compact unit. In addition, it would be desirable to provide features that maximize usability of the appliance in order to encourage a consumer to continue the use of the appliance. The device of the present disclosure addresses at least these and other shortcomings as present in conventional appliances.

### BRIEF SUMMARY OF THE DISCLOSURE

Briefly stated, one aspect of the present disclosure is directed to a combination food steamer and food processor appliance having a housing with a first end and an opposing second end. The housing surrounds a motor and a heater. A water cavity is positioned within the housing. A drive shaft is rotatably driven by the motor. At least a portion of the drive shaft extends upwardly beyond the first end of the housing. A jar is removably mountable to the first end of the housing. The water cavity is located in the housing beneath the jar. The jar has a bottom wall and a side wall extending upwardly therefrom. Portions of the bottom wall and side wall of the jar define a food processing cavity. At least a portion of the drive shaft extends through a portion of the bottom wall of the jar when the jar is mounted to the housing. A lid is removable mountable to a rim of the side wall of the jar. A basket is removably mountable within the food processing cavity of the jar in a first operating configuration. The basket includes a bottom wall and a side wall extending upwardly therefrom. Portions of the bottom wall and side wall of the basket define a food steaming cavity. At least a portion of the drive shaft extends through a portion of the bottom wall of the basket in a first operating configuration. At least one cutting mechanism is rotatably driven by or on the drive shaft.

In another aspect, the present disclosure is directed to a combination food steamer and food processor having a housing with a bottom wall and a side wall extending upwardly therefrom. Portions of the bottom wall and side wall of the housing define a water cavity. A motor is positioned within the housing. The motor is generally laterally surrounded by the water cavity (i.e., the water cavity is located “next to” the motor on all sides but not above or below the below per se). The drive shaft is rotatable by the motor. At least a portion of the drive shaft extends upwardly beyond the side wall of the housing. A heater is positioned within the water cavity for heating water within the water cavity to produce steam. A jar is removably mountable to the upper end of the side wall of the housing. The water cavity in the housing is located beneath the jar. The jar has a bottom wall and a side wall extending upwardly therefrom. Portions of the bottom wall and side wall of the jar define a food processing cavity. At least a portion of the drive shaft extends through a portion of the bottom wall of the jar when the jar is mounted to the housing. A divider wall extends upwardly from the bottom wall of the jar. The divider wall and an interior surface of a portion of the side wall of the jar define a steam cavity (i.e., a separate space apart from the food-containing portion of the appliance). The divider wall separates the food processing cavity from the steam cavity. A lid is removably mountable to the rim of the side wall of the jar. The lid includes a top lid wall and a feed tube extending from the top lid wall along a food axis. The feed tube defines a feed cavity and a mouth for accessing the feed cavity. A food pusher is removably insertable into at least a portion of the feed cavity of the feed tube. The food pusher is movable within at least a portion of feed cavity along a feed axis. A basket is removably mountable within the food processing cavity of the jar in a first operating configuration. The basket includes a bottom wall and a side wall while extending upwardly therefrom. Portions of the bottom wall and side wall of the basket define a food steaming cavity. At least a portion of the drive shaft extends through a portion of the bottom wall of the basket in the first operating configuration. The combination further includes at least one cutting mechanism rotatable by the drive shaft.

### BRIEF DESCRIPTION OF THE SEVERAL VIEWS OF THE DRAWINGS

The foregoing summary, as well as the following detailed description of the disclose, will be better understood when read in conjunction with the appended drawings. For the purpose of illustrating the disclosure, there is shown in the drawings an embodiment which is presently preferred. It should be understood, however, that the disclosure is not limited to the precise arrangements and instrumentalities shown. In the drawings:

FIG. 1 is a top perspective view of a kitchen appliance according to a preferred embodiment of the present disclosure;

FIG. 2 is a partially exploded top perspective view of certain portions thereof;

FIG. 3 is another partially exploded top perspective view of certain portions thereof;

FIG. 4 is a partially exploded top plan view of certain portions thereof;

FIG. 5 is a cross-sectional side elevational view of certain portions thereof, wherein the kitchen appliance is shown in a first operating configuration;

FIG. 6 is a cross-sectional top perspective view of certain portions thereof, wherein the kitchen appliance is shown in the first operating configuration; and

FIG. 7 is another cross-sectional top perspective view of certain portions thereof, wherein the kitchen appliance is shown in a second operating configuration.

### DETAILED DESCRIPTION OF THE INVENTION

Certain terminology is used in the following description for convenience only and is not limiting. The words “lower,” “bottom,” “upper” and “top” designate directions in the drawings to which reference is made. The words “inwardly” and “outwardly” refer to directions toward and away from, respectively, the geometric center of the kitchen appliance, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

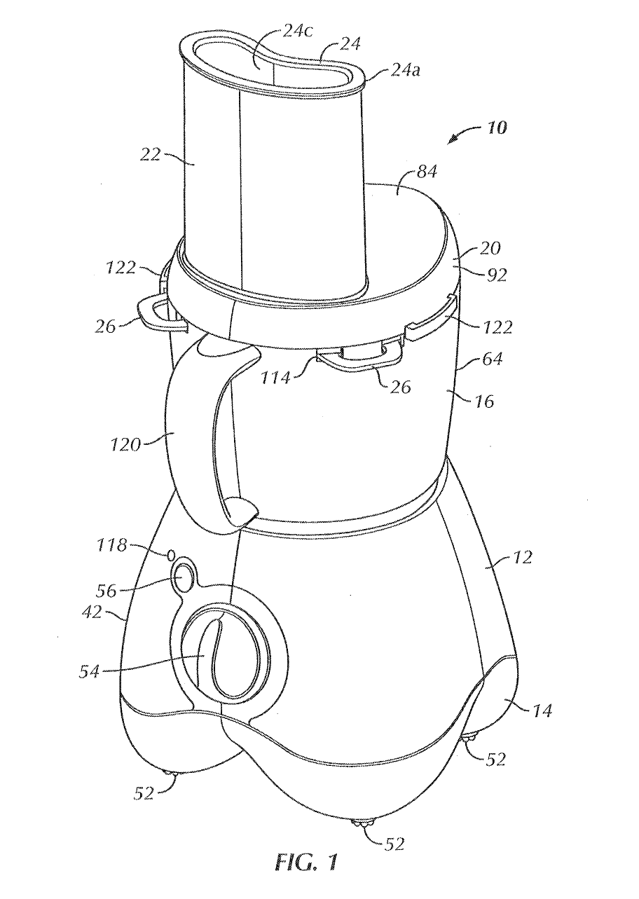

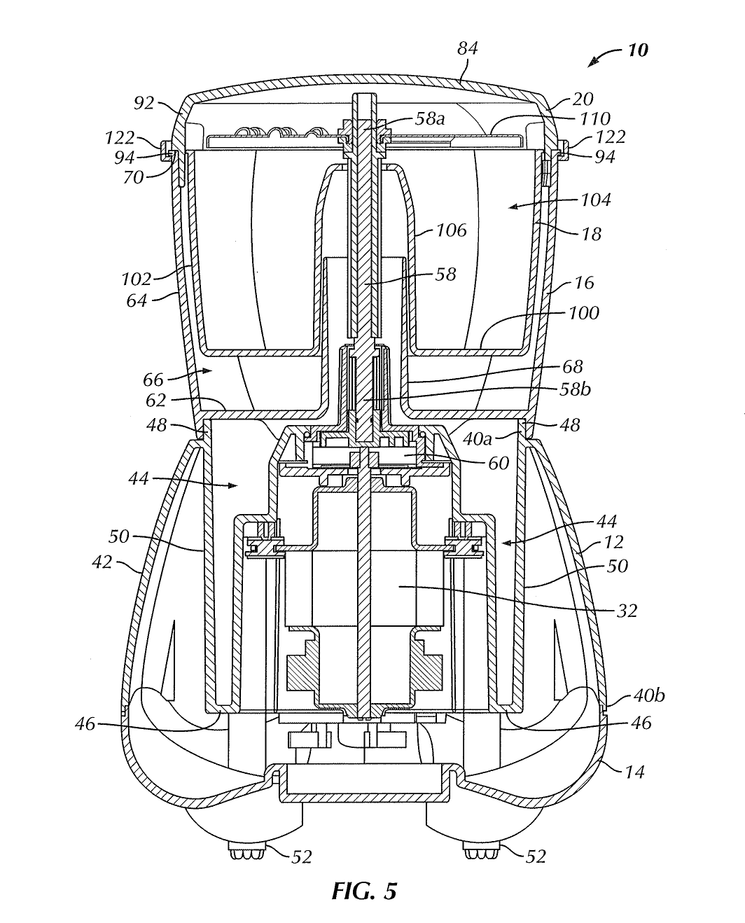

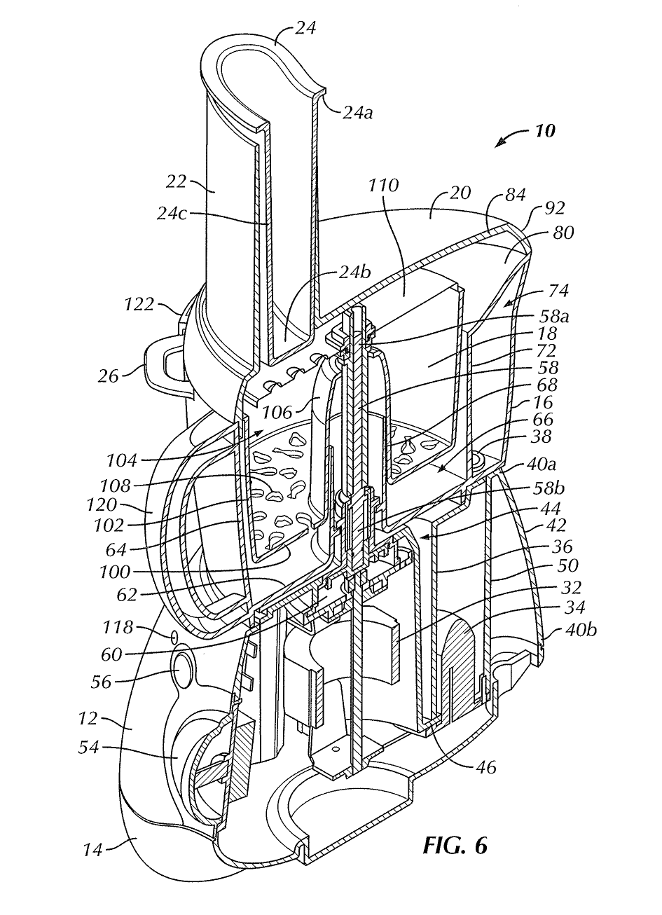

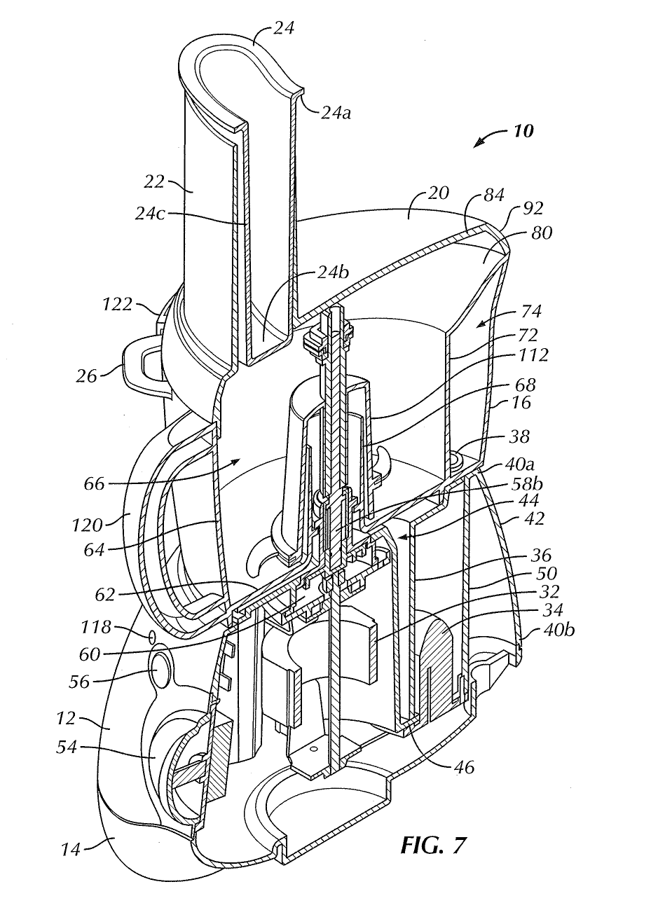

Referring to the drawings in detail, wherein like numerals indicate like elements throughout, FIGS. 1-7 show a preferred embodiment of a kitchen appliance, generally designated 10, of the present disclosure. The kitchen appliance 10 is capable of performing the functions of more than one conventional kitchen appliance. The kitchen appliance 10 is preferably a combination food steamer and food processor, but the present disclosure is not so limited. The kitchen appliance 10 preferably allows a user to steam and/or slice foodstuff (not shown) therein in a first operating configuration (see FIGS. 5 and 6). The kitchen appliance 10 also preferably allows a user to separately process, blend or chop foodstuff therein in a second operating configuration (see FIG. 7). Thus, the kitchen appliance 10 alleviates the need to obtain or buy two or more separate kitchen appliances to perform these functions (i.e., steaming, slicing, grating, chopping, blending, etc.). Further, the kitchen appliance 10 performs the above functionality in a device with a relatively small footprint, which is beneficial in the confines of most kitchens.

Referring to FIGS. 1-7, the kitchen appliance 10 preferably includes a housing 12 having a first or upper end 40a and an opposing second or lower end 40b. An outer side wall 42 of the housing 12 preferably extends from the first end 40a to the second end 40b around an entire outer periphery of the housing 12. As shown in FIGS. 5-7, a motor 32 and a heater 34 are preferably positioned within the housing 12 and generally surrounded by the outer side wall 42 thereof. Electrical power is preferably supplied to the kitchen appliance 10 by connecting an electrical power cord (not shown) to a conventional electrical wall outlet (not shown). However, power may be supplied to the kitchen appliance 10 in other forms, such as by one or more batteries.

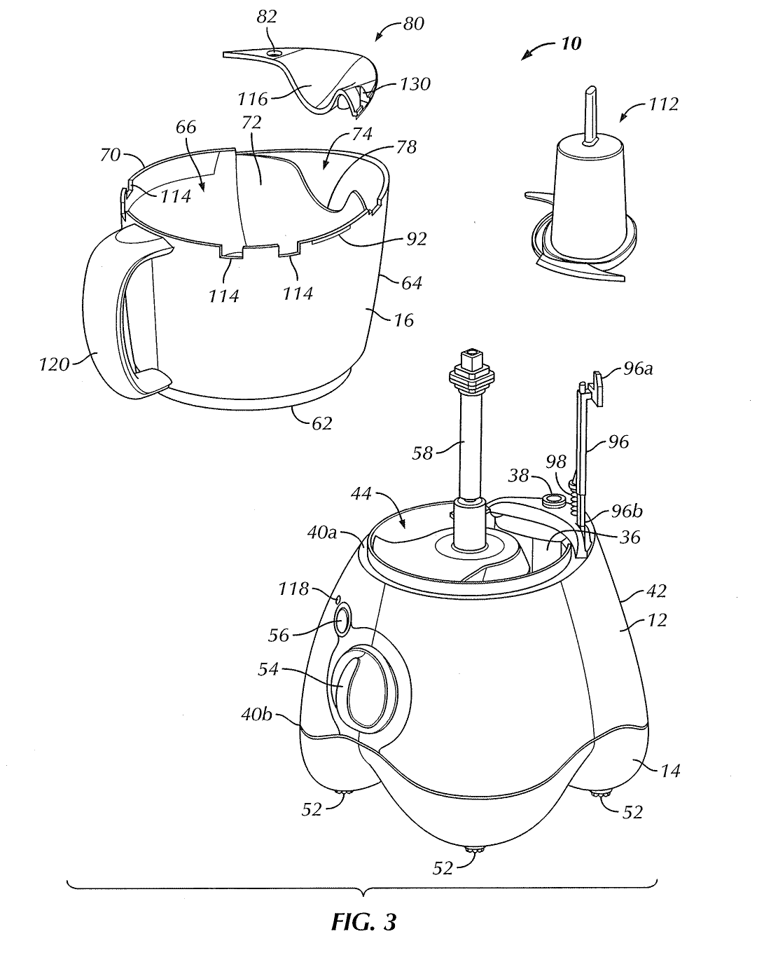

As shown in FIGS. 3-7, a water cavity 44 is preferably positioned within, formed by and/or surrounded by the outer side wall 42 of the housing 12. The motor 32 is preferably generally laterally surrounded by the water cavity 44, but the motor 32 is preferably not in fluid contact with the water cavity 44. In other words, the water cavity 44 is capable of holding water or other liquid (not shown) within the housing 12 separate from the motor 32. The heater 34 is preferably positioned within the water cavity 44 for heating water within the water cavity 44 to produce steam, as described in detail below. In contrast to the motor 32, the heater 34 is preferably in fluid contact with the water cavity 44. As shown in FIG. 5, the water cavity 44 preferably has a closed first or lower end 46 generally proximate the second end 40b of the housing 12, and an opposing second or open upper end 48 generally proximate the first end 40a of the housing 12. As shown in FIG. 3, when the jar 16 of the kitchen appliance 10 is removed from the housing 12, water or any other suitable liquid may be poured into and/or out of the water cavity 44 through the open upper end 48 thereof.

In an embodiment, the upper end 48 of the water cavity 44 is at the same vertical height as the first end 40a of the housing 12, but the present disclosure is not limited to such a configuration. In other words, the upper end 48 of the water cavity 44 may extend above or be located below the first end 40a of the housing 12. A side wall 50 of the water cavity 44 extends from the closed lower end 46 to the open upper end 48 thereof. As shown in FIG. 5, the side wall 50 of the water cavity 44 is preferably laterally spaced-apart from and, more preferably, spaced laterally inwardly from the outer side wall 42 of the housing 12. However, the side wall 50 of the water cavity 44 may be omitted, as the side wall 42 of the housing 12 may form the outer periphery of the water cavity 44.

Referring to FIGS. 3, 4, 6 and 7, a separation wall or heater cover 36 is positioned within the water cavity 44. The separation wall 36 extends from or proximate to the lower end 46 of the water cavity 44 toward or to the upper end 48 thereof. The separation wall 36 can at least partially surrounds and/or encloses the heater 34 with a portion of an interior surface of the side wall 50 of the water cavity 44. It is preferred that the separation wall 36 is not water tight with respect to the water cavity 44. For example, it is preferred that one or more openings or passageways (not shown) are formed between a lower end of the separation wall 36 and the lower end 46 of the water cavity 44, such that water is capable of flowing or passing beneath at least a portion of the separation wall 36 toward or away from the heater 34.

The separation wall 36 can serve several purposes. First, the separation wall 36 may protect the heater 34. Second, the separation wall 36 may prevent a user from accidentally directly contacting the heater 34. Third, the separation wall 36 may define a relatively small space with the portion of the interior surface of the side wall 50, so as to limit the amount of water directly surrounding the heater 34 at any point during operation of the heater 34. The relatively small space allows or enables the heater 34 to more quickly produce steam. Water in the water cavity 44 is preferably capable of flowing beneath at least a portion of the separation wall 36, through the one or more openings or passageways, to the heater 34 from the remainder of the water cavity 44. As the heater 34 heats the water and produces steam, water can flow into the relatively small space defined by the separation wall 36 underneath at least a portion of the separation wall 36 as the top level of water within the water cavity 44 begins to drop and the water seeks equilibrium.

Referring to FIGS. 1-3 and 5-7, the kitchen appliance 10 can include a base 14 fixedly attached to the second end 40b of the housing 12. The base 14 may include one or more spaced-apart feet 52 extending downwardly from a bottom surface thereof. When the kitchen appliance 10 is properly positioned on a tabletop or countertop (none shown), for example, the feet 52 or the bottom surface of the base 14 preferably directly engage the tabletop or countertop to provide a stable foundation for the kitchen appliance 10. As shown in FIGS. 5-7, the base 14 and housing 12 are preferably connected by a tongue-and-groove connection, but the base 14 and housing 12 may be removably or fixedly connected by any of a variety of means.

As shown in FIGS. 1, 3, 4, 6 and 7, a control knob 54 or other control apparatus is mounted to an exterior surface of the side wall 42 of the housing 12. The control knob 54 is preferably operatively connected to the motor 32 in a manner known to those of ordinary skilled in the art. The control knob 54 allows a user to selectively control operation of the motor 32 depending upon the degree or amount of rotation of the control knob 54. For example, the control knob 54 may be rotatable from a “PULSE” position, to an “OFF” position, to a “SLICE/BLEND” position, etc.

Referring again to FIGS. 1, 3, 4, 6 and 7, a steam button 56 and an indicator light 118 could be mounted to a portion of the exterior surface of the side wall 42 of the housing 12. The steam button 56 and the indicator light 118, as illustrated, are positioned at least slightly above and horizontally spaced-apart from the control knob 54, but the present disclosure is not so limited. For example, one or more steam button(s) 56, the indicator light 118 and the control knob 54 may be combined into one structure or control. The steam button 56 is preferably operatively connected to the heater 34 for controlling operation of the heater 34. The steam button 56 is preferably depressible into and out of the exterior surface of the side wall 42 of the housing 12. In an embodiment, the heater 34 is activated by depressing the steam button 56. If and when the heater 34 is operating or is in an “on” condition, the steam button 56 may be depressed to turn the heater 34 “off” In one embodiment, the indicator light 118 is always illuminated anytime the heater is energized. In another embodiment, the indicator light 188 is operatively connected to a sensor (not shown) positioned within or proximate to the water cavity 44. The indicator light 118 preferably illuminates to notify a user if and when the water cavity 44 requires additional water. For example, the temperature of the heater 34 will increase as steam is produced and leaves the housing 12. When the heater 34 reaches a predetermined temperature, the indicator light 118 would illuminate to indicate that additional water is needed in the water cavity to continue to produce steam.

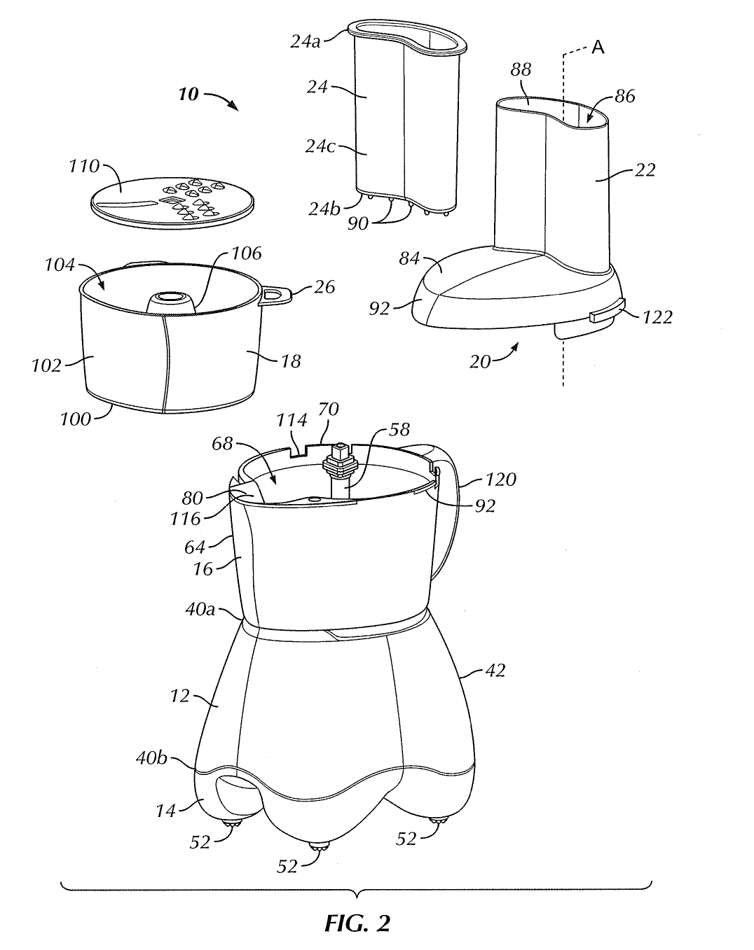

Referring to FIGS. 2-7, a drive shaft 58 is operatively connected to and rotatable by the motor 32. At least a portion of the drive shaft 58 extends upwardly beyond the first end 40a of the housing 12. More specifically, a first or upper end 58a of the drive shaft 58 extends upwardly beyond the first end 40a of the housing 12. At least a portion of a second or lower end 58b of the drive shaft 58 is operatively connected to a planetary or other gear system 60 within the housing 12, which in turn could be surrounded by the water cavity 44. The planetary gear system 60 is preferably operatively connected to and more preferably directly connected to the motor 32, such that actuation of the motor 32 actuates the planetary gear system 60, which in turn actuates or rotates the drive shaft 58.

Referring again to FIGS. 1-7, ajar 16 is removably mountable to and/or supported by the first end 40a of the housing 12. The jar 16 includes a bottom wall 62 and a side wall 64 extending upwardly therefrom. The jar 16 and at least certain other components of the kitchen appliance 10 are preferably formed of a generally light weight, high strength material, such as a polymeric material. It is thought that the jar might be glass, plastic, or the like.

As illustrated, a handle 120 extends outwardly from at least a portion of the side wall 64 of the jar 16. It is preferred that portions of the bottom wall 62 and side wall 64 of the jar 16 define a food processing cavity 66 therein. A hollow column 68 is generally centrally located within the jar 16 and extends upwardly from the bottom wall 62 thereof. Thus, the generally hollow column 68 surrounds an opening that extends through a center of the bottom wall 62 of the jar 16. The column 68 preferably extends from the bottom wall 62 toward an upper open rim 70 of the side wall 64 of the jar 16. More specifically, as illustrated in the one example of FIG. 5, a top end of the column 68 is located at approximately a vertical midpoint of the side wall 64 of the jar 16. At least a portion of the drive shaft 58 extends through a portion of the bottom wall 62 of the jar 16 when the jar 16 is mounted at the housing 12. In one embodiment, at least an upper portion of the drive shaft 58 extends completely through the column 68 of the jar 16 when the jar 16 is mounted to the housing 12.

Referring to FIGS. 3, 4, 6 and 7, a divider wall 72 can extend upwardly from the bottom wall 62 of the jar 16. Portions of the divider wall 72 and an interior surface of a portion of the side wall 64 of the jar 16 define a steam cavity 74. The divider wall 72 of the jar 16 separates the food processing cavity 66 from the steam cavity 74. Food is not and should not be placed or located in steam cavity 74. In the preferred embodiment, the food processing cavity 66 and the steam cavity 74 are preferably laterally adjacent, but the present disclosure is not so limited, as at least a portion of the food processing cavity 66 may be vertically above or below a portion of the steam cavity 74. As shown in FIG. 3, at least a portion of a top surface 78 of the divider wall 72 is vertically below the rim 70 of the side wall 64 of the jar 16. It is envisioned that at least a portion of the top surface 78 of the divider wall 72 would be curved or undulating to permit steam, water and/or foodstuff to pass between the food processing cavity 66 and the steam cavity 74.

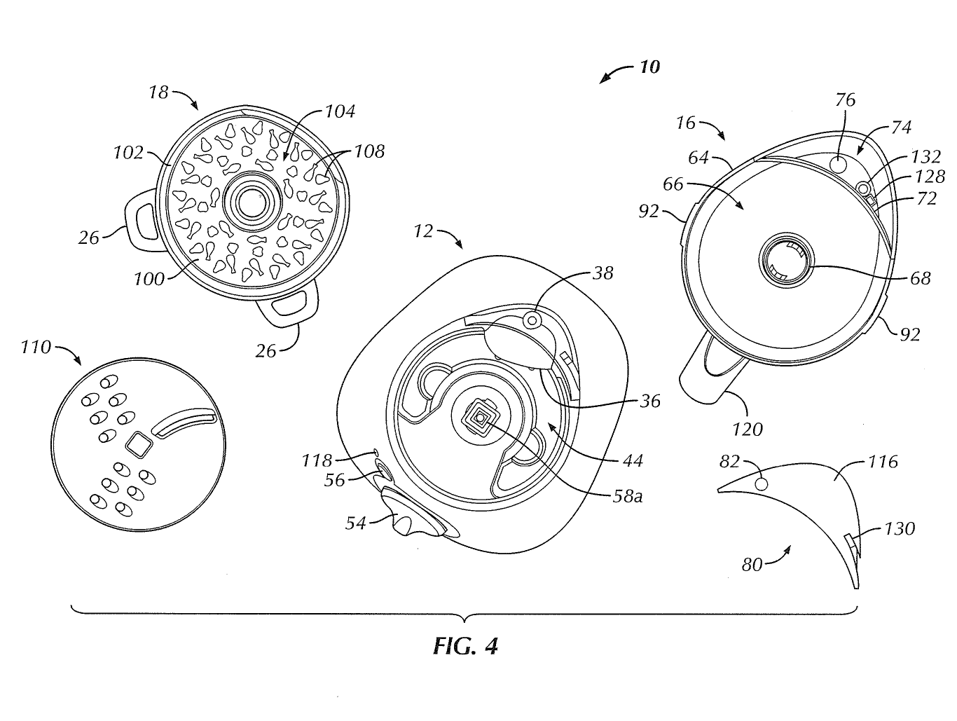

In an embodiment of the subject apparatus, the steam produced in the housing 12 is permitted to easily flow upwardly to the jar 16. More specifically, as shown in FIG. 4, a first opening 76 is formed in the bottom wall 62 of the jar 16 within the steam cavity 74. When the jar 16 is properly mounted to the housing 12, the first opening 76 permits steam produced by the heater 34 within the housing 12 to rise from the water cavity 44 of the housing 12 to the steam cavity 74 of the jar 16. The first opening 76 is illustrated to be generally circular in shape, but the present disclosure is not so limited. As shown in FIGS. 3, 4, 6 and 7, a steam exit port 38 is formed in the housing 12 between the water cavity 44 and the steam cavity 74 of the jar 16. The steam exit port 38 is a passageway, opening or aperature that allows steam to rise from the water cavity 44 of the housing 12 to the steam cavity 74 of the jar 16. At least a portion of the steam exit port 38 extends upwardly beyond the first end 40a of the housing 12 and the upper end 48 of the water cavity 44. An outer periphery of the steam exit port 38 is preferably at least slightly smaller than an inner periphery of the first opening 76 of the jar 16, such that at least a portion of the steam exit port 38 is capable of fitting within the first opening 76 when the jar 16 is properly position or mounted to the housing 12. In other words, the first opening 76 and the steam exit port 38 can be complementarily sized and shaped. The first opening 76 and the steam exit port 38 are substantially aligned so that the handle 120 of the jar 16 is directly or generally above the control knob 54 of the housing 12 when the jar 16 is properly positioned or mounted to the housing 12. Such alignment allows for quick and efficient use of the jar 16 and the housing 12.

Referring to FIGS. 2-4, a pour spout 80 preferably generally encloses an upper end of the steam cavity 74 of the jar 16. As shown in FIG. 3, at least a portion of the pour spout 80 has a shape that compliments or conforms to the curved or undulating shape of the top surface 78 of the divider wall 72. In other words, the pour spout 80 includes a groove or channel 116 in a top surface thereof. When the jar 16 is titled or angled, the channel 116 allows and/or encourages foodstuff and/or liquid within the food processing cavity 66 of the jar 16 to flow over a top surface of the pour spout 80 and out of the jar 16. It is preferred that the pour spout 80 be removably attachable to a portion of the rim 70 of the jar 16 and the top surface 78 of the divider wall to allow for disassembly and/or cleaning of the kitchen appliance 10. The pour spout 80 may include a second opening 82 extending therethrough. The second opening 82 permits steam in the steam cavity 74 to enter the food processing cavity 66. The second opening 82 is illustrated to be generally circular in shape, but the present disclosure is not so limited. The second opening 82 is laterally positioned and/or spaced-apart from the channel 116. Thus, when the jar 16 is titled, foodstuff and/or liquid generally does not enter the second opening 82 or the steam cavity 74 as the foodstuff and/or liquid flows over the pour spout 80 and through the channel 116.

Referring to FIGS. 1, 2 and 5-7, the kitchen appliance 10 may include a lid 20 removably mountable to the rim 70 of the side wall 64 of the jar 16. The lid 20 includes a top lid wall 84 and a feed tube 22 extending upwardly from the top lid wall 84 along a feed axis A (see FIG. 2). As shown in FIG. 2, the feed tube 22 defines a feed cavity 86 and a mouth 88 for accessing the feed cavity 86. The lid 20 has a generally circular shape when viewed from above or below, and may be constructed of an opaque or transparent molded Styrene Acrylonitrile (SAN) material. Alternatively, the lid 20 may be constructed of any metal, glass or suitable material.

The top lid wall 84 is preferably generally flat or planer and the feed axis A preferably extends generally perpendicularly therefrom. A skirt or peripheral rim 92 preferably depends or extends downwardly from the top lid wall 84. The peripheral rim 92 of the lid 20 is releasably engagable with at least a portion of the rim 70 of the jar 16. The peripheral rim 92 may include at least one securing groove or projection 122 that engages a securing lug or groove 94 of the jar 16. However, the lid 20 and jar 16 may be releasably or removably secured in any number of ways, such as through snap-fit or one or more fasteners (not shown).

Referring to FIGS. 1, 2, 6 and 7, a food pusher 24 is removably insertable into at least a portion of the feed cavity 86 of the feed tube 22. The food pusher 24 is movable within at least a portion of the feed cavity 86 along the feed access A. The food pusher 24 could have a generally hollow cylindrical shape with an upper pusher lip 24a and a side wall 24c extending downwardly therefrom to a lower pusher wall 24b. An outer periphery of the side wall 24c of the food pusher 24 is at least slightly smaller than an inner periphery of the feed cavity 86, such that the food pusher 24 is slidable into and out of the feed cavity 86. However, the upper pusher lip 24a of the food pusher 24 preferably has an outer periphery that it is at least slightly larger than the feed cavity 86, such that the food pusher 24 is able to move within the feed cavity 86 only to a point where the upper pusher lip 24a engages a top surface of the feed tube 22. The food pusher 24 is slidable in the feed cavity 86 to urge foodstuff toward the jar 16 when the lid 20 is mounted to the jar 16. A height of the food pusher 24 is preferably at least slightly less than a height of the feed tube 22, such that the food pusher 24 does not and cannot extend into the food processing cavity 66 of the jar 16 when the lid 20 is mounted to the jar 16 and the food pusher 24 is positioned within the feed cavity 86 of the feed tube 22. As illustrated in FIG. 2, a plurality of spaced apart food spikes 90 may extend outwardly or downwardly from the lower pusher wall 24b. The food spikes 90 could engage and/or grip any foodstuff lodged or jammed within the feed cavity 86. The food pusher 24 is not limited to the inclusion of food spikes 90, as the pusher wall 24b may be generally smooth.

Referring to FIG. 3, the kitchen appliance 10 preferably includes a safety interlock 96 operatively connected to at least the motor 32 and the lid 20 to prevent operation of the motor 32 when the lid 20 is removed from the jar 16 or when the lid 20 is not properly positioned on the rim 70 of the jar 16. A sensor (not shown) is preferably positioned within the housing 12 and is operatively connected to both the motor 32 and a second or lower end 96b of the safety interlock 96. The sensor permits or prevents operation of the motor 32 depending upon the position or movement of the safety interlock 96. The safety interlock 96 is preferably generally elongated and includes a biasing member 98, such as a coil spring, that urges or biases the safety interlock 96 in a disengaged or upwardly position with respect to the motor 32. A length or height of the safety interlock 96 is preferably at least slightly greater than a height of the jar 16, as measured along the side wall 64 of the jar 16 from the bottom wall 62 to the rim 70.

When the kitchen appliance 10 is properly assembled, a lower portion of the biasing member 98 may be located in a seat 132 (see FIG. 4) in an upper surface of the bottom wall 62 of the jar 16. Further, when the kitchen appliance 10 is properly assembled, at least a portion of the second or lower end 96b of the safety interlock 96 extends through a hole 128 (see FIG. 4) in the bottom wall 62 of the jar 16 and at least a portion of a first or upper end 96a of the safety interlock extends through a slot 130 (see FIGS. 3 and 4) of the pour spout 80. As shown in FIG. 4, the slot 130 is preferably laterally spaced-apart from the second opening 82 of the pour spout 80, and the hole 128 is preferably laterally spaced-apart from the first opening 76 in the bottom wall 62 of the jar 16. The safety interlock 96 is preferably separable from each of the housing 12, the jar 16 and the lid 20 for disassembly and/or cleaning purposes. However, the safety interlock 96 may be fixed to and/or integrally formed with one or more of the housing 12, the jar 16 and the lid 20.

In operation, when the lid 20 is properly positioned on the jar 16, at least a portion of the lid 20 engages the first or upper end 96a of the safety interlock 96, which in turn urges the entire safety lock 96 downwardly against the bias of the biasing member 98 toward the housing 12. The downward force of the lid 20 on the first end 96a of the safety interlock 96 preferably overcomes the opposing upward force of the biasing member 98 to push the entire safety interlock 96 at least slightly downwardly with respect to and/or into the housing 12, which is sensed or recognized by the sensor (not shown). At this point, the sensor places the motor 32 in an “active” or operating state, such that rotation of the control knob 54 can effectuate operation of the motor 32.

Referring to FIGS. 2 and 4-6, a basket 18 is preferably removably mountable within the food processing cavity 66 of the jar 16. The basket 18 is placed within the jar 16 in the first operating configuration (FIGS. 5 and 6) and removed from the jar 16 in the second operating configuration. However, the basket 18 may be placed in the jar 16 in a storage configuration or for other purposes. Furthermore, the kitchen appliance 10 may steam foodstuff within the jar 16 in the first operating condition even if the basket 18 is not placed within the jar 16. The basket 18 includes a bottom wall 100 and a side wall 102 extending upwardly therefrom. Interior portions of the bottom wall 100 and side wall 102 of the basket 18 define a food steaming cavity 104. A generally hollow column 106 preferably extends upwardly from the bottom wall 100 of the basket 18 and is generally centrally positioned within the basket 18. Thus, the generally hollow column 106 surrounds an opening that extends through a center of the bottom wall 100 of the basket 18. The column 106 preferably extends from the bottom wall 100 proximate to, but preferably at least slightly short of, an upper open rim of the side wall 102 of the basket 18. When the basket 18 is properly positioned within the jar 16 (i.e., first operating configuration), and the jar 16 is properly mounted to the housing 12, at least a portion of the column 68 of the jar 16 extends into an interior of the column 106 of the basket 18. Further, at least a portion of the drive shaft 58 preferably extends through a portion of the bottom wall 100 of the basket 18 when the jar 16 is mounted at the housing 12 and the basket 18 is placed within the jar 16. More preferably, at least an upper portion of the drive shaft 58 extends completely through the column 106 of the basket 18 when the jar 16 is mounted at the housing 12 and the basket 18 is placed within the jar 16.

As shown in FIGS. 1, 2, 4, 6 and 7, at least one or two spaced-apart handles 26 can extend outwardly from an exterior surface of the side wall 102 of the basket 18 proximate an upper end thereof. When the basket 18 is properly positioned within the jar 16, at least a portion of each handle 26 extends through a cut-out 114 in the jar 16. Each cut-out 114 extends at least slightly downwardly from the rim 70 of the jar 16. The handles 26 of the basket 18 facilitate placing the basket 18 into the jar 16 and removing the basket 18 from the jar 16. The handles 26 are shown in the figures to be generally “U” or “C” shaped. However, the handles 26 may generally be any shape that allows for the above-described functionality. As shown in FIG. 4, the bottom wall 100 of the basket 18 includes a plurality of spaced-apart holes 108 extending therethrough. The holes 108 preferably allow water and/or relatively small portions or particles of the foodstuff to flow from the food steaming cavity 104 of the basket 18 to the food processing cavity 66 and/or the bottom wall 62 of the jar 16.

Referring to FIGS. 2-7, the kitchen appliance 10 preferably includes at least one, and more preferably at least two, separate cutting mechanisms. Each cutting mechanism is preferably sized and shaped so as to be positioned entirely within the space surrounded by the lid 20 and the jar 16 when the lid 20 is properly mounted to the jar 16. Each cutting mechanism is directly attachable to separate portions of the drive shaft 58. It is preferred that, in the case of two separate cutting mechanisms, the cutting mechanism are not simultaneously operated or rotated within the jar 16. However, if desired, the two separate cutting mechanisms may be placed on or attached to the drive shaft 58 at least for storage purposes.

More specifically, a first cutting mechanism 110 may be directly connected to and rotatable by at least a first portion of the drive shaft 58, such as the upper end 58a thereof, in the first operating configuration. A separate second cutting mechanism 112 is preferably directly connected to and rotatable by at least a second portion of the drive shaft 58 in the second operating configuration when the basket 18 and the first cutting mechanism 110 are not positioned within the jar 16. The second portion of the drive shaft 58, which connects to or contacts at least a portion of the second cutting mechanism 112, is preferably positioned between the upper end 58a and the lower end 58b of the drive shaft 58.

The first cutting mechanism 110 is preferably positioned entirely above the column 68 of the jar 16 and the column 106 of the basket 18 in the first operating configuration. The second cutting mechanism 112 preferably surrounds at least a portion of the column 68 of the jar 16 in the second operating configuration. The second cutting mechanism 112 is preferably removed and/or separated from the jar 16 in the first operating configuration. In contrast, the first cutting mechanism 110 and the basket 18 are preferably removed or separated from the jar 16 in the second operating configuration. As illustrated in FIG. 5, the entire first cutting mechanism 110 is positioned above the rim 70 of the jar 16 in the first operating configuration, and the entire second cutting mechanism 112 is positioned below the rim 70 of the jar 16 in the second operating configuration. First cutting mechanism 110, which is a disc shape, can also be below the rim and still be fully functional. In a preferred embodiment, the first cutting mechanism 110 is a generally flat or planar slicing blade, and the second cutting mechanism 112 is an “S”-blade. However, each cutting mechanism 110, 112 may have an alternative form or shape.

If a user intends to employ the kitchen appliance 10 in the first operating configuration to at least steam foodstuff within the kitchen appliance 10, the user may insert or pour water or another liquid into the water cavity 44 of the housing 12. The user preferably then places the jar 16 on top of the housing 12 and inserts the basket 18 into the jar 16. The user may place foodstuff into the food steaming cavity 104 of the basket 18 prior to attaching the lid 20 to the rim 70 of the jar 16. The kitchen appliance 10 may be operated in the first operating configuration with or without the first cutting mechanism 110. For example, the user may attach the first cutting mechanism 110 to the upper end 58a of the drive shaft 58 after the basket 18 is placed in the jar 16.

If a user intends to employ the kitchen appliance 10 in the second operating configuration to process or blend foodstuff within the kitchen appliance 10, the user preferably places the jar 16 on top of the housing 12 and inserts the second cutting mechanism 112 into the jar 16 and onto the drive shaft 58. The user may place foodstuff into the food processing cavity 66 of the jar 16 prior to attaching the lid 20 to the rim 70 of the jar 16, or the user may insert foodstuff through the feed tube 22 and into the jar 16 after the lid 20 is attached to the rim 70 of the jar.

Once electrical power is supplied to the kitchen appliance 10, a user may rotate or the control knob 54 and/or depress the steam button 56 to actuate the motor 32 or the heater 34, respectively. Rotation of the control knob 54 preferably actuates the motor 32, which through the planetary gear system 60 preferably rotates the drive shaft 58 to rotate the first or second cutting mechanisms 110, 112. Rotation of the first cutting mechanism 110 preferably slices foodstuff inserted through the feed tube 22 or positioned within the food processing cavity 66 of the jar 16 or the food steaming cavity 104 of the basket 18. Similarly, rotation of the second cutting mechanism 112 processes, chops and/or blends foodstuff within the food processing cavity 66 of the jar 16. Once the foodstuff has been sufficiently processed, sliced and/or blended, the lid 20 may be removed from the rim 70 of the jar 16 and the jar 16 may be removed from the housing 12 and titled or angled such that the sliced or processed foodstuff can be poured out of the food processing cavity 66 through the pour spout 80.

When the kitchen appliance 10 is in the first operating configuration, depression of the steam button 56 preferably actuates the heater 34. When the heater 34 reaches a sufficiently high temperature, any water within the water cavity 44 preferably at least partially forms steam that rises through the steam exit port 38 and into the steam cavity 74 of the jar 16 through the first opening 76. At least some of the steam preferably rises to the top of the steam cavity 74 of the jar 16 and through the second opening 82 of the pour spout 80. At least some of the steam then preferably enters the food steaming cavity 104 of the basket 18 at least in part because an inner surface of the top lid wall 84 of the lid 20 directs steam downwardly into the basket 18. Any steam that enters the steaming cavity 104 of the basket 18 preferably steams or saturates any foodstuff within the basket 18. Any condensation or water droplets produced from the steam may exit the steaming cavity 104 of the basket 18 through any one of the plurality of holes 108 in the bottom wall 100 of the basket 18.

If the first cutting mechanism 110 is attached to the drive shaft 58 in the first operating configuration, foodstuff may be inserted into and through the feed tube 22 and sliced by the rotating first cutting mechanism 110 as the foodstuff enters the jar 16. The sliced foodstuff may then fall into the food steaming cavity 104 of the basket 18 during or before steam is produced and enters the food steaming cavity 104. Employing the first cutting mechanism 110 prior to or during steaming allows the foodstuff to be more fully saturated to produce softer or mushier foodstuff to be fed to a baby or small child. It should also be noted that employing the first cutting mechanism removes the burden of processing any of the food prior to the steaming operation as the appliance is employed to reduce the food item to a processed form. Further, the processing achieved by employing the first cutting mechanism, places the food in a condition where it will be steamed more quickly. The surface area of the food is greatly increased during the processing achieved by the first cutting mechanism.

Once steaming and/or slicing of the foodstuff is complete, the lid 20 may be removed from the rim 70 of the jar 16 to access the foodstuff within the basket 18. The basket 18 may be removed from the jar 16, and the jar 16 may be removed from the housing 12 and titled or angled such that any water and/or foodstuff particles within the food processing cavity 66 can be poured out of the jar 16 through the pour spout 80.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

What is claimed is:

1. A combination food steamer and food processor appliance, the appliance comprising:
a housing having a first end and an opposing second end, the housing surrounding a motor and a heater;
a water cavity positioned within the housing;
a drive shaft rotatable by the motor, at least a portion of the drive shaft extending upwardly beyond the first end of the housing;
a jar removably mountable to the first end of the housing, the jar having a bottom wall and a side wall extending upwardly therefrom, portions of the bottom wall and side wall of the jar defining a food processing cavity, at least a portion of the drive shaft extending through a portion of the bottom wall of the jar when the jar is mounted to the housing;
a lid removably mountable to a rim of the side wall of the jar;
a basket removably mountable within the food processing cavity of the jar in a first operating configuration, the basket including a bottom wall and a side wall extending upwardly therefrom, the bottom wall and the side wall of the basket defining a food steaming cavity, at least a portion of the drive shaft extending through a portion of the bottom wall of the basket in the first operating configuration; and
at least one cutting mechanism rotatable by the drive shaft.

2. The combination according to claim 1, further comprising:
a first cutting mechanism rotatable by and directly connected to at least a first portion of the drive shaft in the first operating configuration; and
a second cutting mechanism rotatable by and directly connected to at least a second portion of the drive shaft in a second operating configuration.

3. The combination according to claim 2, wherein the first cutting mechanism is a slicing blade and the second cutting mechanism is an S-blade.

4. The combination according to claim 3, wherein the S-blade is removed from the jar in the first operating configuration, and wherein the slicing blade and the basket are removed from the jar in the second operating configuration.

5. The combination according to claim 4, wherein the entire slicing blade is positioned above the rim of the side wall of the jar in the first operating configuration, and wherein the entire S-blade is positioned below the rim of the side wall of the jar in the second operating configuration.

6. The combination according to claim 1, further comprising:
a divider wall extending upwardly from the bottom wall of the jar, portions of the divider wall and an interior surface of a portion of the side wall of the jar defining a steam cavity,
wherein a first opening is formed in the bottom wall of the jar within the steam cavity, the first opening permitting steam produced by the heater to rise from the water cavity of the housing to the steam cavity of the jar.

7. The combination according to claim 6, further comprising:
a pour spout generally enclosing an upper end of the steam cavity of the jar, the pour spout including a second opening extending therethrough, the second opening permitting steam in the steam cavity to enter the food processing cavity.

8. The combination according to claim 7, wherein at least a portion of a top surface of the divider wall is below the rim of the side wall of the jar.

9. The combination according to claim 1, wherein the lid includes a top lid wall and a feed tube extending from the top lid wall along a feed axis, the feed tube defining a feed cavity and a mouth for accessing the feed cavity, a food pusher being removably insertable into at least a portion of the feed cavity of the feed tube, the food pusher being movable within at least a portion of the feed cavity along the feed axis.

10. The combination according to claim 1, wherein a peripheral rim of the lid extends downwardly from the top lid wall, the peripheral rim being releasably engageable with the rim of the side wall of the jar.

11. The combination according to claim 1, wherein the heater is positioned within the water cavity.

12. The combination according to claim 1, wherein the bottom wall of the basket includes a plurality of spaced-apart openings extending therethrough.

13. The combination according to claim 1, further comprising:
a control knob on an exterior surface of the side wall of the housing, the control knob being rotatable and operatively connected to the motor for controlling operation of the motor; and
a steam button on the exterior surface of the side wall of the housing, the steam button being depressible and operatively connected to the heater for controlling operation of the heater.

14. The combination according to claim 1, further comprising:
a safety interlock operatively connected to the motor and the lid to prevent operation of the motor when the lid is removed from the jar, the safety interlock being removable from the housing, the jar and the lid.

15. A combination food steamer and food processor appliance, the appliance comprising:
a housing having a bottom wall and a side wall extending upwardly therefrom, portions of the bottom wall and side wall of the housing defining a water cavity;
a motor positioned within the housing, the motor being generally laterally surrounded by the water cavity.
a drive shaft rotatable by the motor, at least a portion of the drive shaft extending upwardly beyond the side wall of the housing;
a heater positioned within the water cavity, the heater operable to produce steam within the water cavity;
a jar removably mountable to an upper end of the side wall of the housing, the jar having a bottom wall and a side wall extending upwardly therefrom, portions of the bottom wall and side wall of the jar defining a food processing cavity, at least a portion of the drive shaft extending through a portion of the bottom wall of the jar when the jar is mounted to the housing, a divider wall extending upwardly from the bottom wall of the jar, the divider wall and an interior surface of a portion of the side wall of the jar defining a steam cavity, the divider wall separating the food processing cavity from the steam cavity;
a lid removably mountable to a rim of the side wall of the jar, the lid including a top lid wall and a feed tube extending from the top lid wall along a feed axis, the feed tube defining a feed cavity and a mouth for accessing the feed cavity;
a food pusher being removably insertable into at least a portion of the feed cavity of the feed tube, the food pusher being movable within at least a portion of the feed cavity along the feed axis;
a basket removably mountable within the food processing cavity of the jar in a first operating configuration, the basket including a bottom wall and a side wall extending upwardly therefrom, portions of the bottom wall and side wall of the basket defining a food steaming cavity, at least a portion of the drive shaft extending through a portion of the bottom wall of the basket in the first operating configuration; and
at least one cutting mechanism rotatable by the drive shaft.

16. The combination according to claim 15, further comprising:
at least two cutting mechanisms, each cutting mechanism being attachable to separate portions of the drive shaft, one of the two cutting mechanisms being rotated by the drive shaft in the first operating configuration, the other of the two cutting mechanisms being rotated by the drive shaft in a second operating configuration.

17. The combination according to claim 16, wherein the at least two cutting mechanisms include:
a slicing blade rotatable by and directly connected to at least a first portion of the drive shaft in the first operating configuration, the slicing blade being enclosed by the lid and the jar when the lid is placed on the rim of the side wall of the jar; and
an S-blade rotatable by and directly connected to at least a second portion of the drive shaft in the second operating configuration.

18. The combination according to claim 15, further comprising:
a steam exit port formed in the housing between the water cavity and the steam cavity of the jar;
wherein, in the first operating configuration, water within the water cavity is heated by the heater to produce steam, the steam rising from the water cavity through the steam exit port and into the steam cavity of the jar and into the food steaming cavity of the basket

19. The combination according to claim 15, wherein the jar includes a pour spout generally enclosing an upper end of the steam cavity of the jar.

20. The combination according to claim 15, further comprising:
a safety interlock operatively connected to the motor and the lid to prevent operation of the motor when the lid is removed from the first end of the jar, the safety interlock being removable from the housing, the jar and the lid.
